(19) United States
(12) Patent Application Publication
(10) Pub. No.: US 2008/0034567 A1
(43) Pub. Date: Feb. 14, 2008

(54) Apparatus and method for installing a belt

(75) Inventors: Patrick D. Galbreath, Louisville, KY (US); Brian Riddle, Nicholasville, KY (US); Paul Louis Cavanaugh, Fort Wayne, IN (US); Anthony Leon Braun, Berne, IN (US); James Robert Crowell, Huntertown, IN (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/497,780

(22) Filed: Aug. 2, 2006

(51) Int. Cl. B23P 11/00; B23P 19/02

(52) U.S. Cl. 29/428; 29/235

(57) ABSTRACT

A tool for operatively coupling a drive mechanism to a driven component is provided. The drive mechanism includes a drive shaft. The tool includes at least two members. Each member includes an inner surface forming an inner lip extending along a first axial edge of each member. The inner lip is positioned within a groove defined within the drive shaft. Each member also includes an outer surface and a channel defined within the outer surface. The outer surface is tapered between the channel and the first axial edge. The tool further includes at least one seal removably coupled to the at least two members. The at least one seal is configured to retain the at least two members about the drive shaft.

### BACKGROUND OF THE INVENTION

This invention relates generally to a drive mechanism for appliances, such as washing machines, and, more particularly, to a tool for installing a belt on a pulley system of the drive mechanism.

Many conventional household appliances, such as washing machines, include a pulley system having a drive pulley coupled to a motor and a driven pulley. The driven pulley is coupled to the drive pulley with a belt. A short center distance is defined between the drive pulley shaft and the driven pulley shaft, thus making installation of the belt on the pulleys challenging. Improper installation of the belt may result in a decrease in belt life and/or belt walk off during use. Further, reinstalling or replacing a belt may be difficult due to the positioning of the pulley system within the appliance cabinet.

### BRIEF DESCRIPTION OF THE INVENTION

In one aspect, a tool for operatively coupling a drive mechanism to a driven component is provided. The drive mechanism includes a drive shaft. The tool includes at least two members, each member including an inner surface forming an inner lip at a first axial edge of each member. The inner lip is positioned within a groove defined within the drive shaft. Each member also includes an outer surface and a channel defined within the outer surface. The outer surface is tapered between the channel and the first axial edge. The tool further includes at least one seal removably coupled to the at least two members such that the at least one seal is configured to retain the at least two members about the drive shaft.

In a further aspect, a drive mechanism for an appliance is provided. The drive mechanism includes a motor having a drive shaft, and a tool configured to couple a belt to the drive shaft. The tool includes at least two members. Each member has an inner surface forming an inner lip at a first axial edge of each member. The inner lip is positioned within a groove defined within the drive shaft. Each member also has an outer surface, and a channel defined within the outer surface. The outer surface is tapered between the channel and the first axial edge. The tool further includes at least one seal removably coupled to the at least two members. The at least one seal is configured to retain the at least two members about the drive shaft.

In a further aspect, a method of assembling a drive mechanism is provided. The method includes providing a drive mechanism including a motor having a drive shaft, and coupling a belt to the drive shaft with a tool including at least two members. Each member includes an inner surface forming an inner lip at a first axial edge. The inner lip is positioned within a groove defined within the drive shaft. Each member also includes an outer surface, and a channel defined within the outer surface. The outer surface is tapered between the channel and the first axial edge. The tool further includes at least one seal removably coupled to the at least two members. The at least one seal is configured to retain the at least two members about the drive shaft.

In a further aspect, a drive shaft for operatively coupling a drive mechanism to a driven component is provided. The drive shaft includes a first tapered portion and a substantially cylindrical portion extending from said first tapered portion, said cylindrical portion including a plurality of circumferential grooves configured to engage a portion of a belt for facilitating maintaining the belt in contact with said cylindrical portion.

### BRIEF DESCRIPTION OF THE DRAWINGS

FIG. 1 is a perspective view of an exemplary washing machine.

FIG. 2 is a partial sectional view of the washing machine shown in FIG. 1.

FIG. 3 is a perspective view showing an exemplary belt drive system for the washing machine shown in FIG. 1.

FIG. 4 is a perspective view of an exemplary tool for the belt drive system shown in FIG. 3.

FIG. 5 is a sectional view of the tool shown in FIG. 4.

FIG. 6 is a front perspective view of an exemplary tool, drive shaft, and drive belt for the belt drive system shown in FIG. 3.

FIG. 7 is a front perspective view of an exemplary tool and drive shaft for the belt drive system shown in FIG. 3.

FIG. 8 is a front perspective view of a portion of an exemplary drive shaft for the washing machine as shown in FIG. 1.

### DETAILED DESCRIPTION OF THE INVENTION

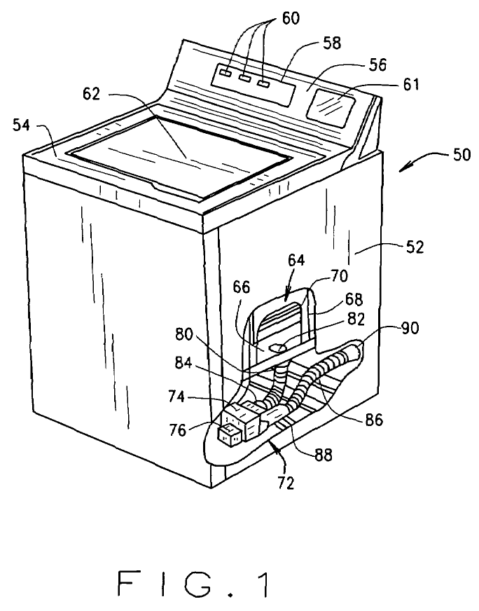

FIG. 1 is a perspective view of an exemplary washing machine 50 including a cabinet 52 and a cover 54. A backsplash 56 extends from cover 54, and a control panel 58 including a plurality of input selectors 60 is coupled to backsplash 56. Control panel 58 and input selectors 60 collectively form a user interface input for operator selection of machine cycles and features. In one embodiment a display 61 indicates selected features, a countdown timer, and/or other items of interest to machine users. A lid 62 is mounted to cover 54 and is movable about a hinge (not shown) between an open position (not shown) facilitating access to a wash tub 64 located within cabinet 52, and a closed position (shown in FIG. 1) forming a sealed enclosure over wash tub 64. As shown in FIG. 1, machine 50 is a vertical axis washing machine. It is apparent to those skilled in the art and guided by the teachings herein provided that the present invention may be incorporated into other washing machines, such as a horizontal axis washing machine, as well as into any suitable household or industrial appliance.

Wash tub 64 includes a bottom wall 66, a side wall 68, and a basket 70 that is rotatably mounted within wash tub 64. A pump assembly 72 is located beneath wash tub 64 and basket 70 for gravity assisted flow when draining wash tub 64. Pump assembly 72 includes a pump 74 and a motor 76. A pump inlet hose 80 extends from a wash tub outlet 82 in tub bottom wall 66 to a pump inlet 84, and a pump outlet hose 86 extends from a pump outlet 88 to a water outlet 90 and ultimately to a building plumbing system discharge line (not shown) in flow communication with water outlet 90.

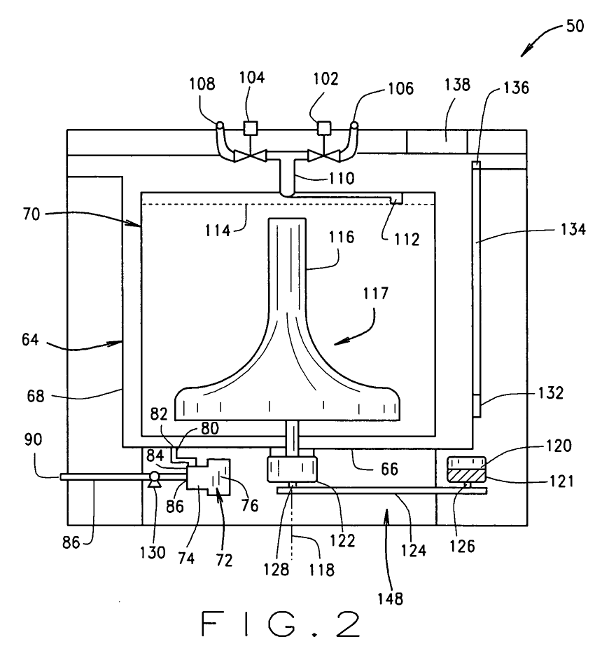

FIG. 2 is a partial sectional view of washing machine 50 including basket 70 movably disposed and rotatably mounted in wash tub 64 in a spaced apart relationship from side wall 68 and tub bottom 66. In one embodiment, basket 70 includes a plurality of perforations therein to facilitate fluid communication between an interior of basket 70 and wash tub 64. In an alternative embodiment, only a bottom (not shown in Figures) of basket 70 is perforated.

A hot liquid valve 102 and a cold liquid valve 104 deliver fluid, such as water, to basket 70 and wash tub 64 through a respective hot liquid hose 106 and a cold liquid hose 108. Liquid valves 102, 104 and liquid hoses 106, 108 together form a liquid supply connection for washing machine 50 and, when connected to a building plumbing system (not shown), provide a fresh water supply for use in washing machine 50. Liquid valves 102, 104 and liquid hoses 106, 108 are connected to a basket inlet tube 110, and fluid is dispersed from inlet tube 110 through a known nozzle assembly 112 having a number of openings therein to direct washing liquid into basket 70 at a given trajectory and velocity. A known dispenser (not shown in FIG. 2), may also be provided to produce a wash solution by mixing fresh water with a known detergent or other composition for facilitating cleaning of articles in basket 70.

In an alternative embodiment, a known spray fill conduit 114 (shown in phantom in FIG. 2) may be employed in lieu of nozzle assembly 112. Along the length of spray fill conduit 114 are a plurality of openings arranged in a predetermined pattern to direct incoming streams of water in a downward tangential manner towards articles in basket 70. The openings in spray fill conduit 114 are located at a predetermined distance or distances apart from one another to accommodate a constant or variable spacing as desired to produce an overlapping coverage of liquid streams into basket 70. Articles in basket 70 may therefore be uniformly wetted even when basket 70 is maintained in a stationary position.

A washing apparatus 116 is mounted within basket 70. Washing apparatus 116 imparts mechanical energy directly to a load in basket 70 to clean the load. In an exemplary embodiment, washing apparatus 116 is a known agitation element mounted within basket 70. In other embodiments, washing apparatus may take other forms, such as an impellor, a pulsator, or a neutator, all of which are well known in the art. In the discussion that follows, washing apparatus 116 will be referred to generally as agitation element 117.

As illustrated in FIG. 2, agitation element 117 is oriented to rotate about a vertical axis 118. Basket 70 and agitation element 117 are driven by a variable speed motor 121. An inverter 120 is operatively coupled to motor 121 and is configured to control motor 121 in response to signals from a controller 138. A drive belt 124 is coupled to respective pulleys of a motor drive shaft 126 and an agitator input shaft 128 as will be described. In one embodiment, a clutch system 122 facilitates driving engagement of basket 70 and agitation element 117 for rotatable movement within wash tub 64. In a particular embodiment, clutch system 122 facilitates relative rotation of basket 70 and agitation element 117 for selected portions of wash cycles. Motor 121, clutch system 122, when present, and agitation element 117 collectively are referred to herein as a machine drive system 148.

Pump assembly 72 is selectively activated to remove liquid from basket 70 and wash tub 64 through drain water outlet 90 and a drain valve 130 during appropriate points of washing cycles. In one embodiment, washing machine 50 also includes a reservoir 132, a tube 134, and a pressure sensor 136. As fluid levels rise in wash tub 64, air is trapped in reservoir 132 creating a pressure in tube 134, which pressure sensor 136 monitors. Liquid levels, and more specifically, changes in liquid levels in wash tub 64 are sensed, for example, to indicate laundry loads and/or to facilitate associated control decisions. In alternative embodiments, load size and/or cycle effectiveness is determined and/or evaluated using other known indicia, such as motor spin, torque, load weight, motor current, and/or voltage or current phase shifts. Further, drive system 148 may be configured to be current limited, voltage limited, or torque limited.

In one embodiment, operation of machine 50 is controlled by controller 138, which is operatively coupled to the user interface input located on washing machine backsplash 56 (shown in FIG. 1) for user manipulation to select washing machine cycles and/or features. In response to user manipulation of the user interface input, controller 138 operates the various components of machine 50 to execute selected machine cycles and/or features.

The washing operation is initiated through operator manipulation of control input selectors 60 (shown in FIG. 1). In one embodiment, washing machine 50 is a direct drive washer that is configured to provide a basket wash wherein laundry items are washed by oscillating basket 70 and agitation element 117 together. That is, basket 70 and agitation element 117 rotate as a unit with no relative motion therebetween. The mechanical wash action is achieved by the relative motion between the laundry items and the basket and agitation element combination, 70 and 117 respectively, when wash tub 64 is filled with a wash liquid. Basket 70 and agitation element 117 are moved back and forth in an oscillatory motion. In one embodiment, basket 70 and agitation element 117 are rotated clockwise about the vertical axis 118 of the machine, and then rotated counterclockwise about the vertical axis 118. The clockwise/counterclockwise reciprocating motion is sometimes referred to as a stroke, and the agitation phase of the wash cycle constitutes a number of strokes in sequence. Acceleration and deceleration of basket 70 and agitation element 117 during the strokes imparts mechanical energy to articles in basket 70 for cleansing action. In washing machine 50, reversible motor 121 provides the stroke action during agitation of the laundry items.

In an alternative embodiment, agitation element 117 and basket 70 are rotatable with respect to one another to provide a conventional wash cycle. In such embodiments, washing machine 50 includes clutch 122 that is configured to lock and unlock basket 70 and agitation element 117 in response to signals from controller 138. In an exemplary embodiment, clutch 122 is a two-position clutch that is controlled to lock and unlock agitation element 117 to basket 70 and to lock and unlock basket 70 to wash tub 64. During agitation, basket 70 is locked and agitation element 117 oscillates within basket 70 to agitate the laundry items. Agitation element 117 is directly driven by reversing motor 121 without a transmission. In alternative embodiments, this washing machine design includes a conventional basket having perforated side walls. When washing machine 50 is configured to provide a conventional wash, washing machine 50 may also be provided with a mode shifter (not shown) to couple agitation element 117 and basket 70 together during spin operations and lock basket 70 in place during agitation.

After the agitation phase of the wash cycle is completed, wash tub 64 is drained with pump assembly 72. Laundry items are then rinsed and portions of the cycle repeated, including the agitation phase, depending on the particulars of the wash cycle selected by a user.

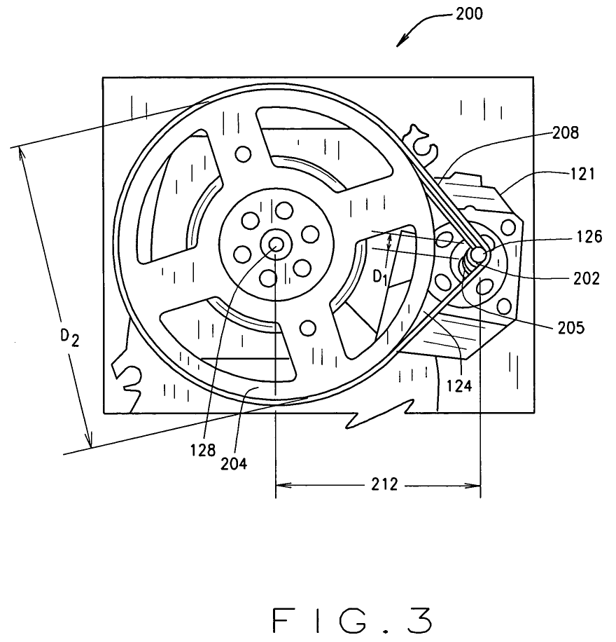

FIG. 3 is a perspective view showing an exemplary belt drive system 200 for a washing machine such as washing machine 50. Belt drive system 200 includes reversible motor 121 having a drive shaft 126 and a first pulley 202. Belt drive system 200 also includes a second pulley 204 mounted on agitator input shaft 128. A drive belt 124 operatively couples first pulley 202 and second pulley 204.

In one embodiment, as shown in FIG. 7, drive shaft 126 is substantially cylindrical and includes an arcuate outer surface. Drive shaft 126 further includes a flat portion 203 and a plurality of grooves 205 extending along a portion of drive shaft 126. In one embodiment, grooves 205 do not form a helical thread but rather include a plurality of substantial parallel circumferential bands defined around drive shaft 126. In an alternative embodiment, grooves 205 form a helical thread about at least a portion of drive shaft 126.

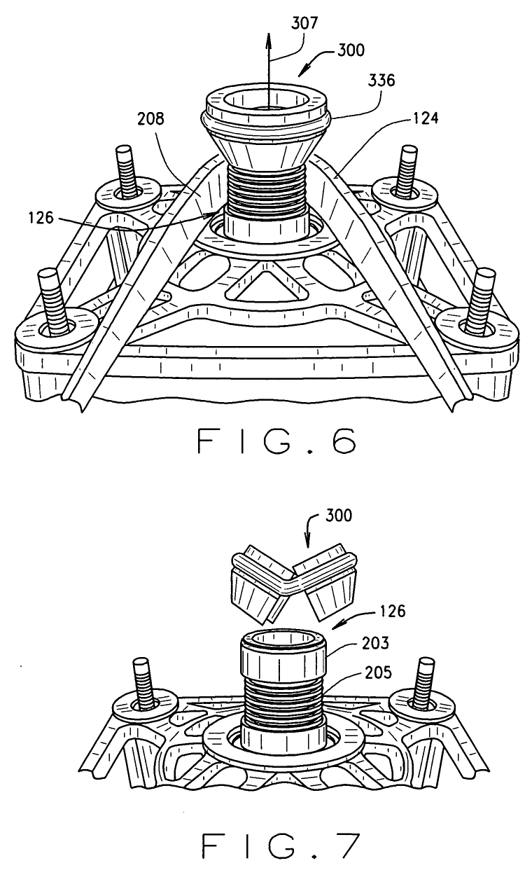

Drive belt 124 couples first pulley 202 and second pulley 204. In one embodiment, drive belt 124 is fabricated from a suitable rubber material. In alternative embodiments, drive belt 124 is fabricated from a plastic and/or other suitable material. In a particular embodiment, motor 121 is a direct drive motor that drives agitation element 117 without the use of a transmission. In this embodiment, pulleys 202 and 204 effectively provide a gear reduction that eliminates the need for a transmission. In one embodiment, drive belt 124 is a known V-belt that has ribs 208 formed on an inner surface of drive belt 124, as shown in FIG. 6.

First pulley 202 has a diameter D₁ and second pulley 204 has a second diameter D₂. Speed reduction from motor 121 to agitator input shaft 128 is determined by the ratio of diameter D₂ to diameter D₁. When washing machine 50 is designed to provide the basket wash, the ratio of diameter D₂ to D₁ is greater than the ratio of diameter D₂ to D₁ when washing machine 50 is designed to provide the conventional wash because the basket wash requires a higher torque than the conventional wash. In one embodiment, the ratio of diameter D₂ to D₁ is at least twelve to one for the basket wash mode. In alternative embodiments, for the conventional wash, the ratio of diameter D₂ to D₁ is at least six to one. A center distance 212 is defined between a rotational axis of drive shaft 126 and a rotational axis of agitation input shaft 128. In one embodiment, center distance 212 is at least partially based on the ratio of diameter D₂ to D₁.

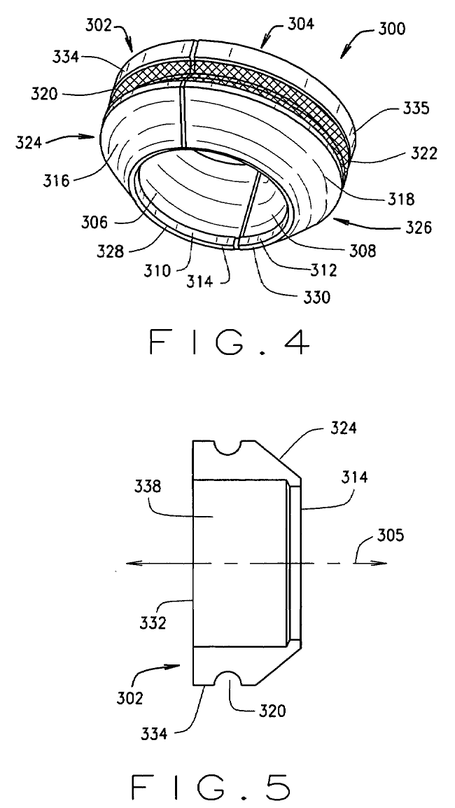

FIG. 4 is a perspective view of an exemplary tool 300 for a belt drive system such as belt drive system 200. FIG. 5 is a sectional view of tool 300. FIG. 6 is a perspective view of exemplary tool 300, drive shaft 126, and drive belt 124 for exemplary belt drive system 200. FIG. 7 is a perspective view of tool 300 and drive shaft 126. Tool 300 is used to install drive belt 124 on first pulley 202 to overcome a force created by drive belt 124. In conventional belt drive systems, after installing drive belt 124 on second pulley 204, drive belt 124 may slide off drive shaft 126. It may be desirable to prevent or limit contact between drive belt 124 and flat portion 203 of drive shaft 126 to prevent or limit damage to drive belt 124, such as shredding of drive belt 124. In one embodiment, tool 300 is used with drive shaft 126.

Tool 300 includes at least two members 302 and 304. Alternatively, tool 300 is a single member. Each member 302 and 304 includes an actuate inner surface 306 and 308, respectively. Inner surfaces 306 and 308 correspond to the outer surface of drive shaft 126. Each inner surface 306 and 308 forms an inner lip 310 and 312, respectively, at a first axial edge 314 of each member 302 and 304. An axis 305 extends through tool 300. When tool 300 is in use, axis 305 is configured to align with an axis 307 of drive shaft 126. Inner lips 310 and 312 are configured to be positioned within grooves 205 of drive shaft 126.

In one embodiment, each member 302 and 304 includes an outer surface 316 and 318, respectively. Each member 302 and 304 further includes a channel 320 and 322, respectively, defined within outer surfaces 316 and 318. Each outer surface 316 and 318 includes a tapered portion 324 and 326, respectively, extending between respective channels 320 and 322 and first axial edge 314. Each tapered portion 324 and 326 forms an outer portion 328 and 330, respectively, extending outwardly at first axial edge 314. In one embodiment, outer portions 328 and 330 are configured to engage a portion of ribs 208 to maintain drive belt 124 in contact with drive shaft 126 during installation of drive belt 124 such that outer portions 328 and 330 are positioned between adjacent ribs 208. Alternatively, outer portions 328 and 330 do not engage a portion of ribs 208.

Each member 302 and 304 includes a second axial edge 332 opposing first axial edge 314. Each member 302 and 304 also includes a flange portion 334 and 335 extending between channels 320 and 322, respectively, and second axial edge 332.

In one embodiment, tool 300 is fabricated from steel. In an alternative embodiment, tool 300 is fabricated from any suitable material including, without limitation, a metal, alloy, composite and/or plastic material. In a particular alternative embodiment, tool 300 is fabricated from a 20 percent glass-filled polycarbonate material.

Further, tool 300 includes at least one seal 336 that is removably positioned within channels 320 and 322 for facilitating retaining members 302 and 304 about drive shaft 126. In one embodiment, seal 336 is positioned within channels 320 and 322 such that seal 336 maintains members 302 and 304 in contacting relationship with one another, as shown in FIG. 6. In this embodiment, seal 336 is resilient to allow members 302 and 304 to move with respect to one another, as shown in FIG. 7. In a particular embodiment, seal 336 is an O-ring. In alternative embodiments, seal 336 is any suitable seal for facilitating retaining members 302 and 304 about drive shaft 126.

When members 302 and 304 are adjacent one another and seal 336 is positioned within channels 320 and 322, inner surfaces 306 and 308 collectively define an opening 338 extending therethrough. Opening 338 is configured to extend around a portion of drive shaft 126. In one embodiment, opening 338 is cylindrical and generally corresponds to an outer surface of drive shaft 126.

Tool 300 facilitates assembling belt drive system 200. In one embodiment, drive belt 124 is coupled to drive shaft 126 using tool 300. Tool 300 is assembled such that inner surfaces 306 and 308 form opening 338 and seal 336 is positioned within channels 320 and 322. Once tool 300 is assembled, ribs 208 of drive belt 124 are positioned around second pulley 204. Drive belt 124 is then stretched towards first pulley 202. Tool 300 engages a portion of drive shaft 126 such that inner surfaces 306 and 308 contact flat portion 203 of drive shaft 126 and each inner lip 310 and 312 is positioned between adjacent grooves 205 defined within drive shaft 126. Drive belt 124 is stretched around tool 300 such that ribs 208 formed on drive belt 124 engage additional grooves 205 defined around drive shaft 126. In one embodiment, at least one rib 208 and/or a portion of drive belt 124 contacts outer portion 328 and/or outer portion 330 of tool 300.

Inner lips 310, 312, outer portions 328, 330 and/or tapered portions 324 and 326 maintain drive belt 124 in contact with drive shaft 126 without drive belt 124 sliding off of drive shaft 126. Tapered portions 324 and 326 are formed at a suitable angle to prevent drive belt 124 from inverting onto itself due to forces created by drive belt 124 on shaft 126 and/or 128. A force may be created by stretching drive belt 124 from a relaxed configuration to a stretched configuration such that internal forces of drive belt 124 urge drive belt 124 toward the relaxed configuration.

As shown in FIG. 7, in one embodiment, tool 300 is removable from drive shaft 126. A suitable force is applied to second axial edge 332 and/or flange portions 334 and 335 to move a portion of members 302 and 304 outwardly with respect to drive shaft 126 and release inner lips 310 and 312 from within grooves 205 defined within drive shaft 126.

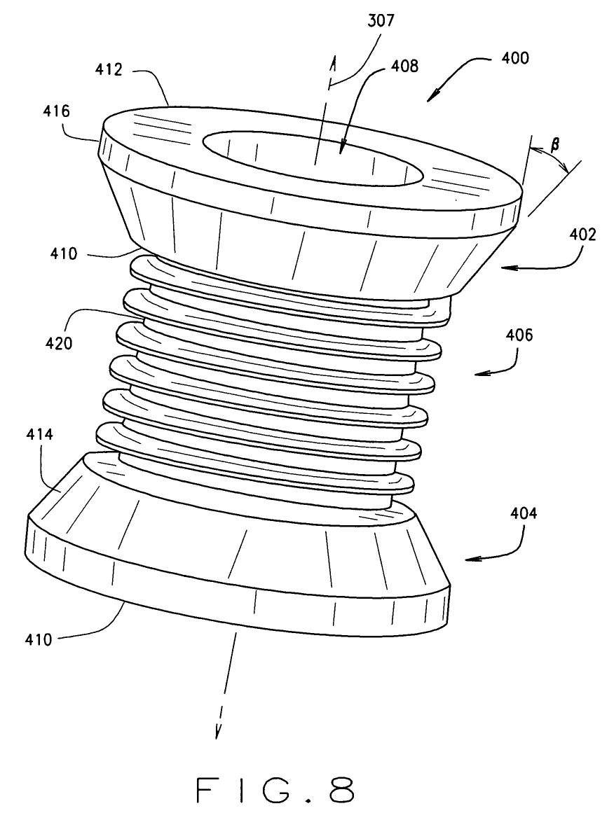

FIG. 8 is a perspective view of an alternative drive shaft 400 for washing machine 50. In one embodiment, drive shaft 400 replaces drive shaft 126 in belt drive system 200. Alternatively, drive shaft 400 is an alternative embodiment to agitator input shaft 128.

In one embodiment, drive shaft 400 includes a first tapered portion 402 and/or an opposing second tapered portion 404, and a substantially cylindrical portion 406 extending therebetween. Alternatively, drive shaft 400 includes only first tapered portion 402. Drive shaft 400 having first tapered portion 402 and second tapered portion 404 is positionable in a plurality of orientations.

An opening 408 extends through portions 402, 404, and 406. Opening 408 is configured to align with axis 307. In one embodiment, opening 408 is cylindrical and is configured to correspond to cylindrical drive shaft 126.

Tapered portion 402 includes a first axial surface 410 and second tapered portion 404 includes an opposing second axial surface 412. As shown in FIG. 8, each tapered portion 402 and 404 includes a flat taper 414. Alternatively, each tapered portion 402 and 404 includes a curved taper (not shown). In one embodiment, tapered portions 402 and 404 are positioned at an angle β with respect to central axis 307 to keep drive belt 124 engaged with drive shaft 400 and prevent and/or limit undesirable rotation or movement of drive belt 124 along axis 307. In this embodiment, angle β is an acute angle. In a particular embodiment, each tapered portion 402 and 404 includes a flange portion, such as flange portion 416 that extends outwardly from tapered portion 402 towards axial surface 410. As shown in FIG. 8, flange portion 416 is parallel to center axis 307. In alternative embodiments, tapered portion 402 and/or tapered portion 404 includes a flange portion having any suitable width or does not include a flange portion.

Cylindrical portion 406 includes an arcuate outer surface defining a plurality of grooves 420 extending about portion 406. In a particular embodiment, grooves 420 do not form a helical thread but rather include a plurality of substantial parallel circumferential bands defined around drive shaft 126. In an alternative embodiment, grooves 420 form a helical thread about at least a portion of drive shaft 126. Grooves 420 are configured to engage or interfere with ribs 208 of drive belt 124.

In one embodiment, drive shaft 400 includes grooves 420 and/or tapered surfaces 402 and/or 404 machined or otherwise formed in drive shaft 400. In an alternative embodiment, a small pulley is fabricated including grooves 420 and/or tapered surfaces 402 and/or 404 and the pulley is coupled about the motor drive shaft. During assembly of belt drive system 200, with drive shaft 400 coupled to motor 121 or, alternatively, drive shaft 400 coupled about the motor drive shaft, drive belt 124 is coupled to drive shaft 400 such that grooves 420 engage a portion of drive belt 124 and ribs 208 interfere with grooves 420. Tapered portion 402 and/or tapered portion 404 urges drive belt 124 to center drive belt 124 within grooves 420, thus ensuring that each rib 208 is properly seated within a corresponding groove 420. In the exemplary embodiment, while installing drive belt 124 on drive shaft 400, first tapered portion 402 and/or second tapered portion 404 facilitates installing drive belt 124.

Drive shaft 400 allows for hands-free and tool-free installation of drive belt 124. Drive shaft 400 ensures that ribs 208 engage or interfere with grooves 420 to prevent improper installation of drive belt 124. Improper installation of drive belt 124 may shorten the useful life of drive belt 124.

In one embodiment, drive shaft 400 is integrally formed with ribs 208 and at least one tapered portion 402 and/or 404. In alternative embodiments, first pulley 202 includes grooves and at least one tapered portion, similar to those described above for drive shaft 400. In such an embodiment, the grooves and at least one tapered portion are integrally formed with first pulley 202 such that first pulley 202 can be couple to drive shaft 126.

While the invention has been described in terms of various specific embodiments, those skilled in the art will recognize that the invention can be practiced with modification within the spirit and scope of the claims.

What is claimed is:

1. A tool for operatively coupling a drive mechanism to a driven component, said drive mechanism including a drive shaft, said tool comprising:
at least two members, each member comprising an inner surface forming an inner lip at a first axial edge of each member, said inner lip positioned within a groove defined within the drive shaft, each said member further comprising an outer surface and a channel defined within said outer surface, said outer surface tapered between said channel and said first axial edge; and
at least one seal removably coupled to said at least two members, said at least one seal configured to retain said at least two members about the drive shaft.

2. A tool in accordance with claim 1 wherein said tool further comprises an outer portion extending from said outer surface along said first axial edge of each member.

3. A tool in accordance with claim 2 wherein said drive shaft is configured to engage a belt comprising a plurality of ribs.

4. A tool in accordance with claim 3 wherein said outer portion is configured to maintain said belt in contact with the drive shaft during installation of said belt.

5. A tool in accordance with claim 1 wherein said at least one seal is positioned within said channel, and said at least one seal is configured to hold said at least two members adjacent one another.

6. A tool in accordance with claim 1 wherein the drive shaft comprises an outer surface, each said inner surface is configured to correspond to said outer surface of the drive shaft.

7. A tool in accordance with claim 1 wherein each said inner surface is arcuate, said inner surfaces positioned adjacent one another to define an opening extending therethrough, said opening is configured to extend around a portion of the drive shaft.

8. A tool in accordance with claim 1 wherein said tool further comprises a second axial edge opposing said first axial edge and a flange portion, said flange portion extends from said channel towards said second axial edge.

9. A tool in accordance with claim 8 wherein said tool is configured to be removable from the drive shaft such that applying pressure to said second axial edge releases said inner lip from within said groove defined within the drive shaft.

10. A tool in accordance with claim 1 wherein said tool comprises at least one of a metal, alloy, composite and plastic material.

11. A tool in accordance with claim 1 wherein said at least one seal is an O-ring.

12. A drive mechanism for an appliance comprising:
a motor including a drive shaft; and
a tool configured to couple a belt to the drive shaft, said tool comprising at least two members, each member comprising an inner surface forming an inner lip at a first axial edge of each member, said inner lip positioned within a groove defined within said drive shaft, each said member further comprising an outer surface, and a channel defined within said outer surface, said outer surface tapered between said channel and said first axial edge, and at least one seal removably coupled to said at least two members, said at least one seal configured to retain said at least two members about said drive shaft.

13. A drive mechanism in accordance with claim 12 wherein said belt further comprises a plurality of ribs, each said member further comprises an outer portion configured to maintain said belt in contact with said drive shaft.

14. A drive mechanism in accordance with claim 12 wherein said at least one seal is positioned within said channel, said at least one seal is configured to hold said at least two members in contacting relationship.

15. A drive mechanism in accordance with claim 12 wherein said each said member further comprises a second axial edge and a flange portion, said flange portion extends from said channel towards said second axial edge, said tool is configured to be removable from the drive shaft such that applying pressure to said second axial edge releases said inner lip from within said groove defined within the drive shaft.

16. A drive mechanism in accordance with claim 12 wherein each said inner surface is arcuate, said inner surfaces of said members positioned with respect to one another to define an opening extending therethrough, said opening is configured to extend around a portion of the drive shaft.

17. A method of assembling a drive mechanism, said method comprising:
providing a drive mechanism including a motor including a drive shaft; and
coupling a belt to the drive shaft with a tool including at least two members, each member including an inner surface forming an inner lip at a first axial edge of each member, the inner lip positioned within a groove defined within the drive shaft, each member further comprising an outer surface, and a channel defined within the outer surface, the outer surface tapered between the channel and the first axial edge, at least one seal removably coupled to the at least two members, the at least one seal configured to retain the at least two members about the drive shaft.

18. A method in accordance with claim 17 wherein the tool further includes an outer portion extending outwardly from said outer surface along said first axial edge of each member and the belt further includes a plurality of ribs, said method further comprising positioning the outer portion between adjacent ribs of the plurality of ribs.

19. A method in accordance with claim 17 wherein the tool further includes a second axial edge and a flange portion, the flange portion extending from the channel towards a second axial edge, said method further comprising removing the tool from the drive shaft wherein applying pressure to the second axial edge releases the inner lip from within the groove defined within the drive shaft.

20. A drive shaft for operatively coupling a drive mechanism to a driven component, said drive shaft comprising:
a first tapered portion; and
a substantially cylindrical portion extending from said first tapered portion, said cylindrical portion including a plurality of circumferential grooves configured to engage a portion of a belt for facilitating maintaining the belt in contact with said cylindrical portion.

21. A drive shaft in accordance with claim 20 wherein said drive shaft defines an opening extending therethough.
